(19) United States
(12) Patent Application Publication
(10) Pub. No.: US 2017/0363021 A1
(43) Pub. Date: Dec. 21, 2017

(54) Dual engine automobile

(71) Applicant: Brandon Nedelman, Oceanside, CA (US)

(72) Inventor: Brandon Nedelman, Oceanside, CA (US)

(21) Appl. No.: 15/188,958

(22) Filed: Jun. 21, 2016

(51) Int. Cl. F02D 25/02; F02D 41/26; B60K 17/16; B60K 5/02; B60K 17/08; B60K 5/08; F16H 63/50; F02D 9/10

(52) U.S. Cl. CPC F02D 25/02; F16H 63/50; F02D 41/26; F02D 9/1065; B60K 5/02; B60K 17/08; B60K 5/08; B60K 17/16

(57) ABSTRACT

The invention is an automobile with two engines, where one engine is mounted in the front of the car and one is mounted in the back of the vehicle. A common drive shaft rotational part is run from engine to engine underneath the vehicle. A machine functioning as both a transmission and a differential is located affixed to the flywheel or clutch of both engines. The common driveshaft is run from trans differential to trans differential. Both engines share a common computer system performing the functions such as ignition and electronic fuel injection.

### TECHNICAL DESCRIPTION OF INVENTION

### Two Engines, Common Drivetrain:

The invention is a dual engine automobile that contains two longitudinal prime mover engines, 12, 21, with one engine, 12, located in the front engine bay of the vehicle, and one engine located in the rear engine bay of the vehicle. The engine bays or engine compartments are located at the far ends of the vehicle, relative the length of the chassis 11. The engine(s) output component(s) 22, 13, face the center of the vehicle, or otherwise face the opposite side of the vehicle. Therefore, both engines are longitudinal engines. Likewise, the drivetrain system of components is longitudinal.

The timing synchronization between the two engines, 12, 21, is secured by a common drivetrain system between the two motors, running underside the length of the vehicle. The entire drivetrain operates in said synchronism, converting the output energy generated by both prime mover/engines 12, 21, located on each far end of the vehicle chassis 11. The drivetrain is comprised of a shaft assembly, comprising two long visible “input shaft” portions and (two transaxles, 26, 15) a mechanically synchronized middle shaft portion running between the two transaxles, 14, 23. Either one, 28, 15, or two, 26, 15, (one per engine/input shaft, 12, 14) transaxles, 15, final drive components (axle(s) 16, /wheel(s) 17, 27 configurations). If the invention has two transaxles, 26, 15, they are mechanically joined and synchronized through a mechanical means located between the two transaxles 14,23. This is a middle shaft or a mechanical linkage 14, 23. It may be one or multiple components that are the assembly forming 14, 23. The purpose of the said, “middle” mechanical linkage serves the purpose of mechanical synchronization and suspension/stability/support purposes. The final-drive-output force from both engines 12, 21, is delivered to the final-drive axle(s) 16, and wheel(s), 17, 27, to make the car roll or move, after the transaxle(s), 15, has/have converted the engine origin, 12, 21, torque level x1 into final drive torque level x3.

Each wheel set is driven by a drive system containing a separate or common (the invention may contain either one, 26, or two, 28,) transaxle assembly(s) 15, for both the front and the rear wheel sets 17, 27 performing the functions of both a differential (final-drive-output machine) and a transmission (torque conversion machine) 15. This machine is called a transaxle 15, or otherwise a torque-conversion/final-drive-output machine unit 15. The housed components in the torque-conversion/final-drive-output machine(s) (transaxle(s)), 15, convert the drive of each wheelset 17, 27 as final drive 24, 29, delivering final drive 24, 29 to the wheels 17, 27. The transaxle(s) 15 also perform(s) the function of variably adjusting gear ratios 25 from engine to final-drive, prior to the directional conversion of final-drive motion, 24, 29. This is known as gear ratio modification or gear reduction in automotive technology terminology, 25.

The engine output components comprise one visible input shaft 14, 23 associated with each engine junctioned likewise to each respective torque transfer mechanisms, inputting the vehicle engine(s) 12, 21 outputted torque into the vehicles torque/gear modification system(transaxle(s)) 15. The visible input shafts are a part of a common assembly, 14, 23, that also includes the middle shaft or mechanical linkage (two transaxle design 26). The input shafts are longer than the usual design of a standard input shaft. They resemble a driveshaft in terms of length and appearance. However, they are not functionally driveshaft's, and this vehicle does not have a driveshaft even though it is a transverse vehicle. A multi-piece assembly may comprise the input shaft assembly 14, 23. Both visible portions of the input shaft (external the transaxle 15) assembly are mechanically joined and synchronized internal of the transaxle 15 (on the model of this application containing a single transaxle.) The single transaxle configuration may feature an additional internal shaft component comprising an additional portion of the input shaft assembly 14, 23. Nonetheless, both input shafts are synchronized internal the transaxle. The model of this invention featuring two transaxles 26 has a different mechanical composition than just stated. The two-transaxle 26 design features two input shaft components 14, 23 one between each engine 12 and its respective transaxle 15, 26. Between the two transaxles is a third visible shaft 14, 23 whose function is to maintain balance throughout the vehicle drivetrain by mechanically securing the major components. This component is just referred to as a shaft or mechanical linkage 14, 23 because there really isn't a name for it. Because a Tot of force is being generated by the combination of two engines, 12,21. It is necessary to join the entire drivetrain in the center of the vehicle as described for balance and synchronous operation of the double transaxle 15, 26 application of this invention.

### Drivetrain:

The dual engine automobile contains a vertical drivetrain system of components that runs the length of the vehicle, in the direction that is parallel the length of the vehicle body/chassis 11 (from front to rear). Therefore, both engines 12, 21 are longitudinal. The common drivetrain allows for a system that prevents minor slippage or deviance that can cause gradually developed problems of mis-synchronization between the two motors, that would later cause problems with synchronization between engines and the drive system. The drivetrain contains one or more multi-function machines that are essentially transaxles 15. A single transaxle 28, or torque-conversion/final-drive-output machine unit 15, performs the functions of A. torque-conversion machine (automotive transmission), and B. final-drive-output machine (such as an automotive differential.) This/these machine(s) is/are dual function machine(s) performing the function of torque-conversion of engine output and delivery of converted torque to the vehicles final drive components. The drivetrain system may contain additional components known as “torque converters”. This is the name for a component found on most automatic transmission vehicles. They convert engine outputted torque prior to transmitting the said torque to the transmission or torque-conversion machine of an automatic transmission vehicle. The additional torque converters on this invention are located at the input shaft/transaxle junction(s) 19.

The transaxle is referred to as a torque conversion/final-drive-output machine unit. It should not be confused with the other common component name located between the engine and torque conversion machine of a car, called a “torque converter” 19.

The invention contains two input shafts 14, 23 transferring torque through the drivetrain from each engine 12, 21, to the engines respective torque input 19 portion of its respective torque conversion/transaxle portion. If the invention has two transaxles 15, 28, it also features a third shaft or mechanical linkage 14, 23 running between the center of the two transaxles 15, 28.

### Drivetrain Applications/Different Mechanical Set Ups:

The invention addresses the following potentials of drivetrain set up in four configurations as follows:

### Single Transaxle, Manual Shift:

In which the drivetrain assembly outputs engine 12, 21 rotation to a single transaxle 15, 26 centrally located of both engines 12, 21 in the center of the chassis 11. This can be considered all-wheel-drive. If the application is a four-wheel vehicle, there are two axles, 16, outputs, 29, or transaxles 15. (one for the front wheels, and one for rear wheels, 17, 27). One input shaft 14, 23, is located between each engine 12, 21 and the single transaxle 15, 28.

The torque conversion is manually operated through a clutch pedal and shift knob design, as inherent to most all well-known manual torque conversion/manual transmission automotive designs.

### Single Transaxle, Automatic Shift:

In this configuration, the drivetrain assembly outputs engine rotation to a single transaxle 28, 15, centrally located of both engines 12, 21. This can be considered all-wheel drive. The torque conversion is automatic. Vacuum lines and engine sensors determine the automatic torque conversion processing and mechanical functions. One input shaft 14, 23 is located between each engine 12, 21 and the single transaxle 15, 28.

### Dual Transaxle, Manual Shift:

The torque conversion is manually operated through a clutch pedal and shift knob design, as inherent to mostly all well-known manual torque conversion/manual transmission automotive designs. The shift controlling mechanics are synchronized or paired between the two 26 torque conversion machines 15, to mechanically synchronize the operation of both units while maintaining the necessary alignment in the drivetrain for the continued operation of the vehicle. One input shaft 14, 23, is located between each engine and the single transaxle. The input shafts 14, 23, transfer torque from the engine to each respective transaxle 15, 26. An additional third shaft 14, 23, adjoins both transaxle units, 26, 15, in the center of the vehicle, between the location of the two transaxles 14, 23.

### Dual Transaxle, Automatic Shift:

The torque conversion process is automatic. vacuum lines and engine management sensors determine the scope of the torque conversion mechanical processes and functions. One input shaft 14, 23, is located between each engine 12, 21 and the single 28 central transaxle 15. The input shafts 14, 23, transfer torque from the engine 12, 21 to each respective transaxle 26, 15. An additional third shaft 14, 23, adjoins both 26 transaxle units 15 in the center of the vehicle, between the location of the two transaxles, 14, 23.

### Additional Drivetrain Specifications:

In the single 28 transaxle, 15, automatic shift application of this invention, each wheel set 17, 27, is driven by a drive system containing a separate or common mechanical assembly 15 for both the front and the rear wheel sets 17, 27, performing the functions of a differential and a transmission. The housed components of the torque conversion/final-drive-output machine unit(s) 15 convert(s) the drive of each engine 12, 21 set from vertical to perpendicular motion, 24, 29, delivering final drive to the wheels 17,27. The machine unit(s) 15 perform(s) the function of variably adjusting gear ratios 25 from engine 12, 21 to final drive output 24, 29, after directional/rotation conversion of source energy to final drive 24, 29.

Gear reduction 24 or shifting is accomplished in the gearing of the transaxle 15. Vehicle engine 12, 21, conditions and operating parameters such as mechanical or electrical input to the shift machine, from sensors, electronic controls, and vacuum lines, dictate the automated/automatic shift 24 performance of functions to be accomplished by the torque-conversion/final-drive-output machine unit(s) 15.

The common drivetrain alignment of all applications/designs, allows for a system that prevents minor mechanical slippage misalignment or deviances that can gradually develop between the two motors, that would ultimately later cause problems.

The shaft assembly 14, 23 extends through the transaxle(s) 15 to the engine(s) 12, 21 on the single 28 torque-conversion/final-drive-output 15 models. Additionally, a component that is located internal the torque-conversion/final drive-output machine unit(s) 15, may constitute a component that is included as a component of the entire, multi-piece shaft assembly 14, 23.

The model/application/design/configuration containing two 26 torque conversion/final-drive-output machine units 15 possessing a means of synchronously pairing or aligning both the entire drivetrain, as well as the shifting of both gear drives 24 inside the units 15. This allows input signal processing by the common computer to be ported to a single computer common output chain of signals distributed commonly to both assemblies simultaneously, pertaining to the drive shifting operations 24 of the vehicle specifically. The vehicle maintains a common vacuum flow from each engine, 12,21, along with electronic control signals distributed to both units 26 simultaneously, so that both units 26 shift automatically in sync 24.

Dual Parallel Clutch Operation: function of the transaxles 15. The manual transmission designs may include a single transaxle 28 that is in the center of the common drivetrain, or dual transaxles 26, where the front clutch is a forward clutch. In both applications, the clutch drive mechanism is shared with the mechanism of the rear engine clutch, which is located after the flywheel 13 but before the transaxle 15. This consists of a common synchronized mechanical linkage of the clutch pedal to the front engine clutch fork, as well as the rear engine clutch fork. The rear engine clutch components are reversed, so that the mechanical linkage can disengage both clutches with single clutch pedal engagement in one direction. Adapted for the front forward biased and rear reversed biased engines 12, 21, the throw out fork operates normally on the front engine. However, since the rear engine is positioned in the opposite direction, the throw out function is achieved backwards relative to the engines operation, through mechanical linkage running all the way to the back of the vehicle.

The clutch pedal linkage is manipulated by the operator clutch pedal. It is common between the two clutch pedals, with a larger hydraulic cylinder for the rear engine clutch, which is disengaged in reversed. Additional clutch system components may feature standard manual clutch automotive parts and mechanisms, including a slave cylinder, master cylinder, and electronic/vacuum controls.

### Computer Control System:

One crankshaft position sensor is located inside of each motor assembly 12, 21, performing the standard functions of ignition, timing, and fuel delivery signal processing. An additional computer process calculates any offset between the two engines 12, 21, based on the sensor hit point of two engines, and temporarily adjusts computer controls, timing, fuel delivery, etc., and generates a check engine code notifying the driver or mechanic of the displacement.

The common computer control system receives separate input signals from sensors on both motors, such as the crankshaft and camshaft position sensors, and adjusts the ignition timing and fuel injection distributed to each motor slightly to conform to individual variables and motor conditions. This is known as channeling or parallel processing.

The combination of sensor input calculations by the cars computer system allows for the separate computer control operations and parameter values per each individual motor. For example, the timing might be advanced on the rear engine white the car is traveling up a steep hill because of weight/load distribution. All the modern computer controls are factored into the calculation of individual engine 12, 21 accommodations by the central computer.

Other controls operate to independently adjust the fuel and ignition electronic controlled parameters for each independent engine. The computer receives distinguishable input signals from sensors in both engines 12, 21, and contains processes both channels or parallel signaling to manipulate each engine independently.

The combination of the regulation of controls for both engines, is/are calculated against each other to drive independent and separate computer controlling for each engine separately. The parallel processing allows both engine inputs to be assigned a separated processing function in the computer, with an additional computer processing means to weigh the processing of both engine computers against each other. The described processing of both individual engine control processes is used to additionally, manipulate each engine central processing, for separate controlling of the motors 12, 21, independent of one another.

### Wireless Drive-By-Wire System:

Mechanical throttle controlling 43, 44, via the gas pedal 41, has recently been replaced in some newer cars by a technology commonly called drive-by-wire. The invention features a drive-by-wire system which is also wireless.

The rear engine is controlled by a wireless drive-by-wire system. This overcomes any problems that may be faced by mechanical linkage that must be fun from the cabin/gas pedal in the front of the vehicle all the way to the back of the vehicle.

The means of wireless signal transmission 42, is likely a securely paired Bluetooth connection between the main computer and another smaller computer regulating the electrical and mechanical positions of the drive-by-wire throttle body 43, 44.

### Technical Problem

The problem faced is that the marketability for high performance vehicles is strong, however modern emissions standards reduce the potential of power capabilities effected by computer controls. In most scenarios, vehicles need to consume more fuel to get better performance, which is also reduced by emissions controls in the name of emissions and fuel economy. Performance of motor vehicles has been historically noted as a major marketability factor in certain types of models. The potential and production of this major market factor has been reduced in the name of economical or green vehicles that must conform with emissions regulations.

### Solution to Problem

The invention provides a dramatic solution in terms of performance potential to vehicles that must conform to emissions standards, while also maintaining the integrity of fuel economy by adjusting the fuel and timing variabilities of modern automotive computer systems.

It allows for similar components to be manufactured and reduced engineering costs to achieve the same solution to the problem. Another problem encountered is general performance and racing issues. If an engine were to be constructed with two or more engines, it could be the most powerful car in the world. Imagine a super car, take the Bugatti Veyron. It is one of the fastest noted cars, containing only one engine.

If a symmetrically designed car featured Veyron engines, as described, it would have twice the power of the original or single engine model, thus being twice as powerful in speed and horsepower.

This invention has the potential to create innovations to racing/performance worlds by allowing extremely fast cars to be built. It also improves on performance issues of lesser or common cars such as hybrids, by offering engineering solutions in symmetrical car design models that can solve performance solutions in a cheap, and efficient way, by allowing models to be designed with two existing engine models/designs.

An engine with two motors can be designed to yield more marketability in terms of performance capabilities, while still maintaining modern emission control regulation standards that conform to things like emissions, stochiometric ratio, closed loop oxygen sensor processing, and fuel economy.

### DESCRIPTION OF DRAWINGS AND EMBODIMENTS

FIG. 1 illustrates the dual engine vehicle with two, torque conversion to final drive machine transfer units. The front and rear engines (prime movers) are labeled 12, and the connected, integrated common drivetrain is outlined in the other portions of the picture. FIG. 13 is the disengage-able manual clutch to flywheel point (if the vehicle is manually operated for final drive output gearing transfer). It could also be on an automatic model of the invention. A flywheel to torque converter junction point, FIG. 13, is the output torque mechanism from the output of engines prime source, 12, to the mechanical operations of the rest of the illustrated drivetrain. 14 is the long input shaft(s) of this invention, their assembly may be one or multiple pieces that extend from engine output point 13, and carry or transmit the outputted mechanical drive force to the processing of drive energy at 15. The final drive that drives or propels the vehicle is outputted from the transaxles at the axles, 16, to the car wheels at 17 as final drive force, or mechanical motion.

FIG. 2 illustrates the dual engine vehicle. Likewise, to FIG. 1, FIG. 2 illustrates the invention where 15 is a single torque conversion final drive transfer machine unit, applicable to both the front and rear wheel sets simultaneously. The front and rear engines are labeled 12,

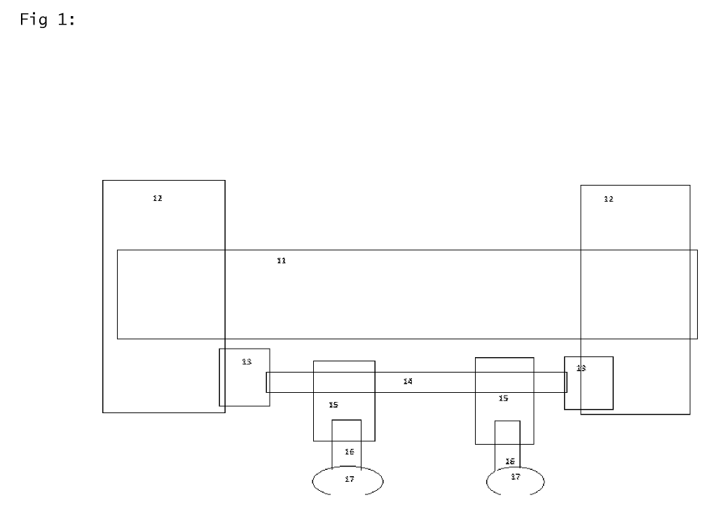

The connected, integrated common shaft assembly is outlined in the other portions of the picture. FIG. 13 is the disengage-able manual clutch to flywheel point (if the vehicle is manually operated for final drive output gearing transfer). FIG. 13 is the output torque mechanism from the output of engines 12, To the mechanical operations of the rest of the illustrated drivetrain. 14 is the shaft assembly. Its assembly may be one or multiple pieces that extend from engine output point 13 and carry or transmit the outputted mechanical drive force to the processing of the drive energy at 15. The shaft assembly portions located between the engines and transaxle(s) 15 are deemed “input shafts”. The final drive that drives or propels the vehicle is outputted from the transaxle at the axle(s) 16 to the car wheels at 17, as final drive or mechanical motion.

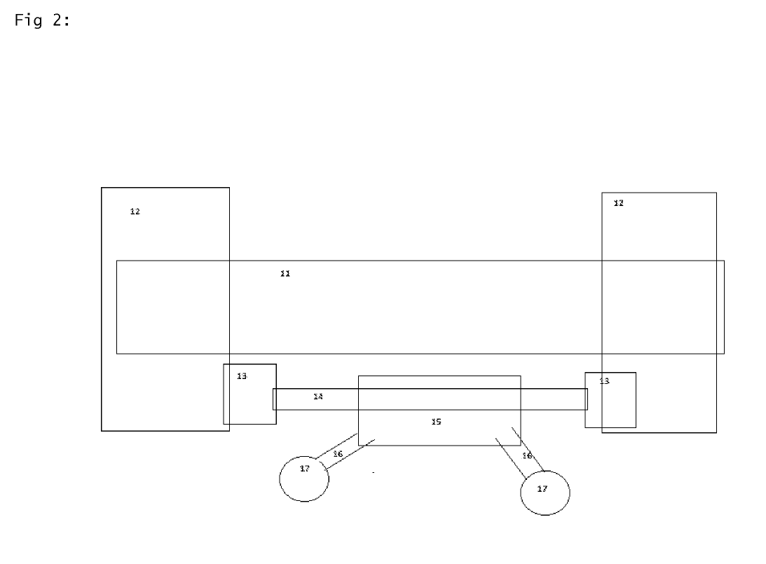

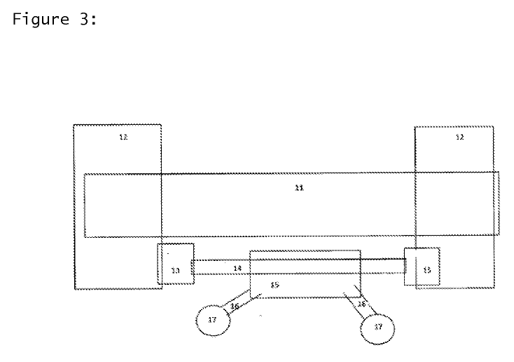

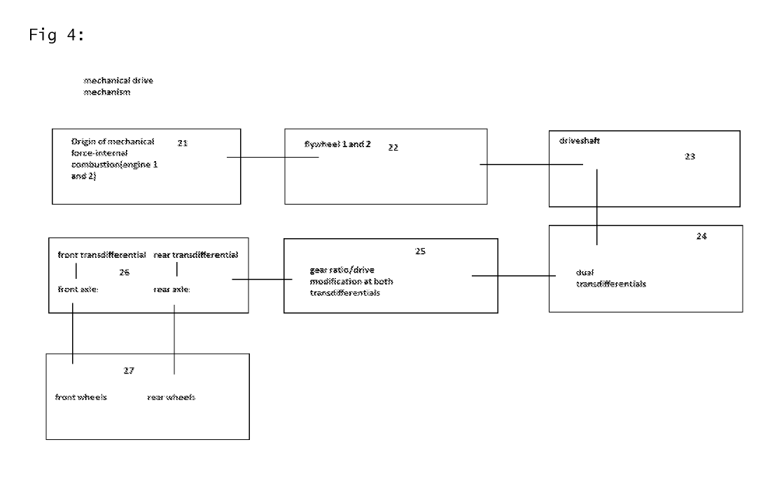

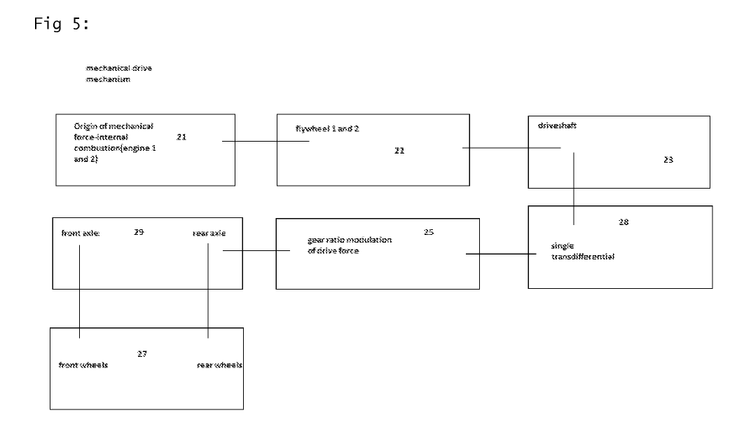

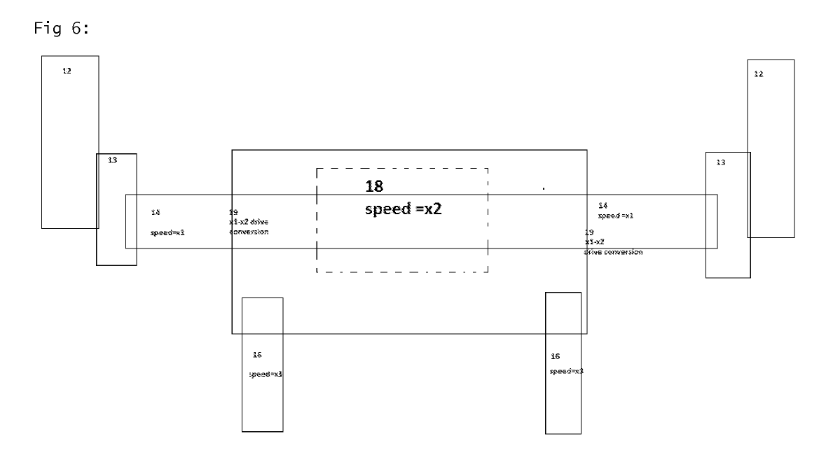

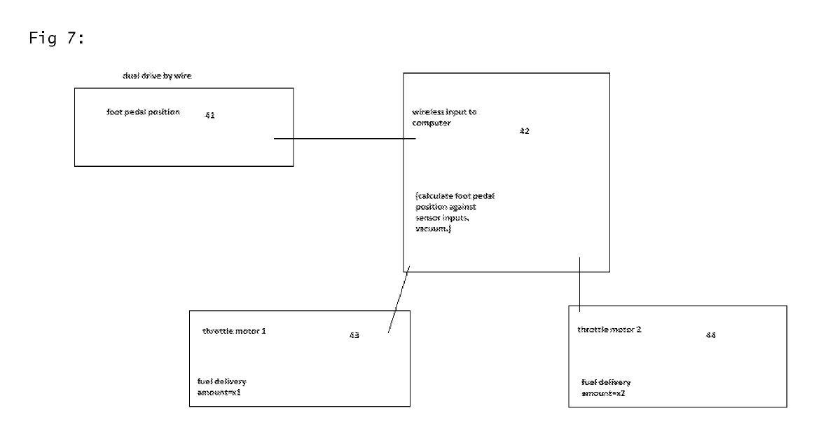

FIG. 3 is a more detailed blueprint of FIG. 2 which features more elaborate drawings of the mechanical components of FIG. 3, the single torque transfer machine design/model of this invention.

FIG. 4 is an outline of the mechanical drive or torque force transfer as it applies to the invention as a single torque conversion/transfer model application as in FIG. 2. 21 represents the internal combustion engine as a prime mover component. Prime mover is another word for engine in many patent literatures related to engine and drivetrain set ups. 22 represents the transfer to the component or components 13, as prime mover or engine outputted torque, to the drivetrain system of components. 23 is the transfer from 13 to 14. 14, The long underside major component is termed a shaft assembly. It may be multiple assembled pieces or components. 24 is the torque transfer component. Torque is converted here, to final drive, through gearing, and then outputted to final drive at the wheels and axles. 26 is the axles. 27 is the wheels. 28 is 24, wherein 24 is accomplished by a single component for both the front and the rear wheel sets. 29 illustrates the operation of 28 as the two wheel sets are distinguishable branched, in terms of mechanical assembly, from the two-separate torque conversion machine units, which are synchronized mechanically by some means.

FIG. 5 is an outline of the mechanical drive or torque force transfer as it applies to the invention as a dual torque conversion/transfer model application as in FIG. 2. 21 represents the internal combustion engine as a prime mover component. Prime mover is another word for engine in many patent literatures related to engine and drivetrain set ups. 22 represents the transfer to the component or components 13, as prime mover or engine outputted torque to the drivetrain system of components, 23 is the transfer from 13 to 14. The long underside major component is termed a shaft assembly (14). It may be multiple assembled pieces or components. It features two “visible input shafts” (14), that run from each engine to a respective input point at the/a transaxle(s), 15. 24 is the torque transfer component. Torque is converted here to final drive through gearing, and then outputted to final drive at the wheels and axles. 26 is the axles. 27 is the wheels. 28 is 24, wherein 24 is accomplished by a single component for both the front and the rear wheel sets. 29 illustrates the operation of 28 as the two wheel sets are distinguishable branched, in terms of mechanical assembly, from the two-separate torque conversion machine units, which are synchronized mechanically by some means.

FIG. 6 is FIG. 2. The processing of torque at different mechanical stages or at different torque levels is realized in this depiction. Output torque x1 is converted to internal transmission gear change torque at junction point 19 as x2. The outputting final drive axles at 16, output the final drive torque level, which is numerically labeled as x3, as final drive torque.

FIG. 7 illustrates the drive-by-wire system of the mechanical throttle control operation fearing a mechanical-part-less, all-electronic operation of a throttle body by an electronic means. 41 indicates the foot or gas pedal position. 42,43 and 44 imply parallel processing of engine control computing, and the said computing factors in the single driver footswitch position is used to calculate and deliver engine parameter functions of computer control to engine electronic components accordingly, per individual engine (parallel or channeled processing of computing). The system likely features drive-by-wire for both throttle bodies and engine computer control channels.

### GLOSSARY

Prime mover; origin of mechanical force in a drivetrain. An internal combustion or hybrid engine.

Torque-conversion; conversion of prime mover torque to final output torque; Gear reduction or manipulation by an automotive transmission or a machine performing the function thereof.

Transaxle: an automotive machine unit component that performs both the functions of torque conversion machine(transmission) and final drive output machine (differential). Referred to as “torque-conversion/final-drive-output machine unit”

Transmission; torque conversion machine of an automobile performing the function of conversion of prime mover energy from one torque parameter to a second torque parameter.

Final drive; the torque or mechanical force or motion that is ultimately applied to the wheels of the vehicle, propelling the vehicle.

Manual transmission; a user controlled and operated torque conversion system in an automobile design, also known as stick shift.

1. An automobile with two engines wherein one engine is located at the front of the length of the chassis while the second engine is located at the rear opposite end of the length of the chassis.

2. The automobile of claim 1 wherein the two engines share a common unified drivetrain system of components, the said drivetrain outputting engine prime mover/source torque to the vehicles final drive components.

3. The automobile of claim 1 wherein the automobile is computer controlled.

4. The automobile of claim 1 wherein the two engines are longitudinal mounted/assembled.

5. The automobile of claim 1 further comprising at least one transaxle which performs the functions of both receiving output engine torque from at least one engine, and transmitting said torque to final drive components of the vehicle.

6. The automobile of claim 2 wherein the engines and the common drivetrain are mechanically synchronized.

7. The automobile of claim 3 wherein each individual engine and its associated set of sensors and computer control electronic components are separately channeled or banked and processed independently of one another by the systems computer.

8. The automobile of claim 3 wherein at least one of the two engines throttle control system is drive-by-wire.

9. The automobile of claim 3 wherein both channel or banks are processed individually and different calculated/separate output controlled engine electronic signal functioning scenarios are distributed to each individual engine per the calculated combination values of both engine banks or channels.

10. The automobile of claim 5 further comprising a manual shift/clutch/throwout system of the transaxle(s) wherein the inherent driver clutch pedal is mechanically junctioned for parallel operation of two independent/separate clutch disk/throw-out mechanisms, wherein one said of each mechanism is respective of each individual engine;

11. The automobile of claim 5 further comprising a common vacuum system routed to the transaxle(s) between the two engines.

12. The automobile of claim 5 further comprising a common integrated computer control system assembled between the two engines and the transaxle(s) for the electronic signal processing consistent with the transaxle(s) gear shifting.

13. The automobile of claim 5 wherein the vehicle contains one transaxle.

14. The automobile of claim 5 wherein the vehicle contains two transaxles.

15. The automobile of claim 10 wherein the mechanical response of clutch pedal depression is the simultaneous disengagement of both clutch disks from established friction/contact to their respective components.

16. The automobile of claim 13 wherein the transaxles gear shifting functions are automatic.

17. The automobile of claim 13 wherein the transaxles gear shifting functions are manually controlled.

18. The automobile of claim 14 wherein the transaxles gear shifting functions are automatic.

19. The automobile of claim 14 wherein the transaxles gear shifting functions are manually controlled.

20. The automobile of claim 15 wherein the throw-out direction of the front engines respective clutch disk is achieved in the direction that is opposite the throw-out direction of the second engines respective clutch disk.
